(19) United States
(12) Patent Application Publication
(10) Pub. No.: US 2017/0105328 A1
(43) Pub. Date: Apr. 20, 2017

(54) Caprock Shovel and Method of Manufacture

(71) Applicant: Seymour Manufacturing Co., Inc., Seymour, IN (US)

(72) Inventors: Loren Wischmeier, Seymour, IN (US); Nolan Bottorff, Seymour, IN (US); Phil Miller, Columbus, IN (US)

(21) Appl. No.: 15/157,552

(22) Filed: May 18, 2016

Related U.S. Application Data
(60) Provisional application No. 62/159,113, filed on May 8, 2015.

(51) Int. Cl. A01B 1/02; B21D 53/66; A01B 1/22

(52) U.S. Cl. CPC A01B 1/02; A01B 1/22; B21D 53/66

(57) ABSTRACT

An improved caprock shovel design with a blade capable of enduring greater stresses than caprock shovel blades known to the art, and of more efficiently performing cutting or breaking tasks, and a cost-effective method of manufacturing the same.

### CROSS-REFERENCES TO RELATED APPLICATIONS

This application claims priority to U.S. Provisional Application No. 62/159,113, Improved Caprock Shovel and Method of Manufacture, filed May 8, 2015, which is incorporated in its entirety herein.

### STATEMENT REGARDING FEDERALLY SPONSORED RESEARCH OR DEVELOPMENT

Not applicable

### BACKGROUND

This invention relates generally to an improved caprock shovel, and to methods for manufacturing such an improved caprock shovel.

Shovels are well known to the art. Shovels, generally, are hand tools consisting of a blade, an attachment portion connected or formed into the blade to accommodate a handle, and a handle. Shovel blades have a variety of profiles and degrees of sharpness, and may be flat or may be formed to create a bowl. Shovel blades may, but need not, include foot rests, which are typically incorporated as a flat portion on top of the blade formed by flattening or bending the blade material.

Shovels known to the art come in a variety of configurations. One such configuration, known as a “caprock” shovel, is designed for breaking up dense or tough material, such as woody roots, clay, coral, or rock. Caprock shovels known to the art feature rounded blade points, relatively small blade radii, and very little lift or angle between the blade and the handle. Typical lifts common to caprock shovels include, by way of example, 2.5 inches and 4 inches. Because of their low lift, caprock shovels are favored for tasks like digging irrigation ditches or landscaping work.

Shovels known to the art, most notably caprock shovels, are typically formed by making the shovel blade, then attaching a handle of desired material and length to the blade. For caprock shovels, the step of making the shovel blade is usually performed by obtaining a shovel blank of thick steel, often as thick as 0.1 inches, and pressing or hammering the blank into a desired blade shape by forging. Because the metal or metal alloy of a forged shovel blade will, as would be appreciated by one skilled in the art, end up with significant variations in thickness after forging, such blades cannot easily be heat treated for strength or to otherwise achieve desirable mechanical characteristics. Thus, caprock shovels known to the art generally comprise blades lacking uniform hardness, which may deform under as little as approximately 200 pounds of weight. It also known to the art to make shovel blades by stamping, however, stamped shovel blades are typically made of relatively thin-gauge steel, such as fourteen or sixteen gauge. Stamped shovel blades typically lack the weight and overall durability of forged shovel blades, and are not suitably heavy for the aggressive cutting tasks for which caprock shovels are designed. Stamping is therefore typically a disfavored manufacturing process to produce blades for caprock shovels. It is desirable to provide a caprock shovel capable of cutting through dense material with increased efficiency, and capable of withstanding greater applied forces than shovels known to the art, as well as a cost-efficient method of manufacturing the same.

### SUMMARY

The present invention is directed to an improved caprock shovel capable of enduring greater stresses than caprock shovel blades known to the art, and capable of more efficiently performing cutting or breaking tasks, as well as to a cost-effective method of producing these improved caprock shovels. Generally, embodiments of an improved caprock shovel of the present invention comprise a blade, where the blade comprises a ground contacting portion, a frog, a shank adjacent the frog, and a socket adjacent to the shank, as well as a handle connected to the shank.

Generally, embodiments of cost-effective methods of producing improved caprock shovels according to the teachings herein comprise the steps of providing a rolled steel blank, stamping said blank into a caprock shovel blade comprising a ground contacting portion, a frog, a shank adjacent to the frog, and a socket adjacent to the shank, selecting a handle, and connecting the handle to the shank.

### BRIEF DESCRIPTION OF THE DRAWINGS

These and other features, aspects, and advantages of the present invention will become better understood with regard to the following description and accompanying drawings, where:

FIG. 1 shows a perspective view of a shovel according to one embodiment of the present invention;

FIG. 2 shows a bottom view of a shovel blade according to one embodiment of the present invention;

FIG. 3 shows a side view of a shovel blade according to one embodiment of the present invention; and

FIG. 4 shows a top down view of a shovel blade according to one embodiment of the present invention.

### DETAILED DESCRIPTION

Embodiments of the present invention provide a number of advantages compared to apparatuses and methods known to the prior art. Specifically, embodiments of the present invention provide an improved caprock shovel capable of withstanding greater stresses during use than caprock shovels known to the art without damage, as well as more efficiently cutting through dense materials. Embodiments of the present invention further provide a cost-efficient method of producing an improved caprock shovel.

An improved caprock shovel according to the teachings of the present invention comprises a stamped steel blade (1) connected to a handle (3). As would be recognized by one skilled in the art, a variety of steel chemistries and steel thicknesses are suitable for use in a steel caprock shovel blade made by stamping. Preferable steels include those amenable to stamping in a substantially uniform thickness, the mechanical characteristics of which are amenable to improvement by heat treating. Most preferably, the apparatus and method of the present invention uses a carbon rolled steel, such as 1050 carbon steel. A number of steel thicknesses, such as fourteen and sixteen gauge steels commonly used to make stamped shovel blades are suitable for use in the improved shovel and method of manufacture described herein. Preferably, however, the improved caprock shovel and method of manufacture described herein uses ten-gauge steel.

Shovel blades (1) may be untreated, or may be tempered or heat treated. Preferably, a shovel blade (1) as taught in the present invention is heat treated after the blank is formed into a shovel blade (1). Heat treating, as would be apparent to one skilled in the art, imparts desired mechanical characteristics to the blade (1), including specifically increased strength properties.

The present invention teaches a caprock shovel with strength characteristics that, under conditions of normal use, are generally commensurate with the materials selected to form the blade (1) and the handle (3). In the preferred embodiment, the blade (1) of the present invention is made of ten gauge, roll-formed, heat-treated carbon 1050 steel. A shovel blade (I) according to the teachings of the present invention can, in normal use, support the weight of a 200-pound man without meaningful deformation. Preferably, a blade (1) according to teachings of the present invention will have a minimum hardness of 42 HRC and a yield strength of at least 80,000 pounds per square inch, or, more preferably a yield strength of at least 110,000 pounds per square inch.

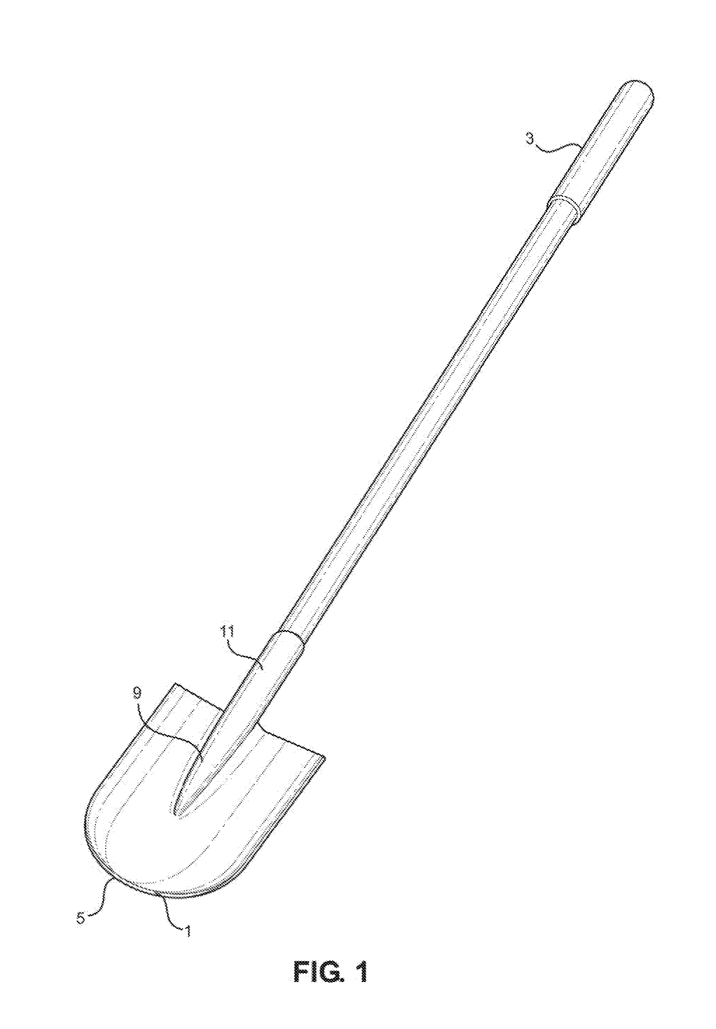

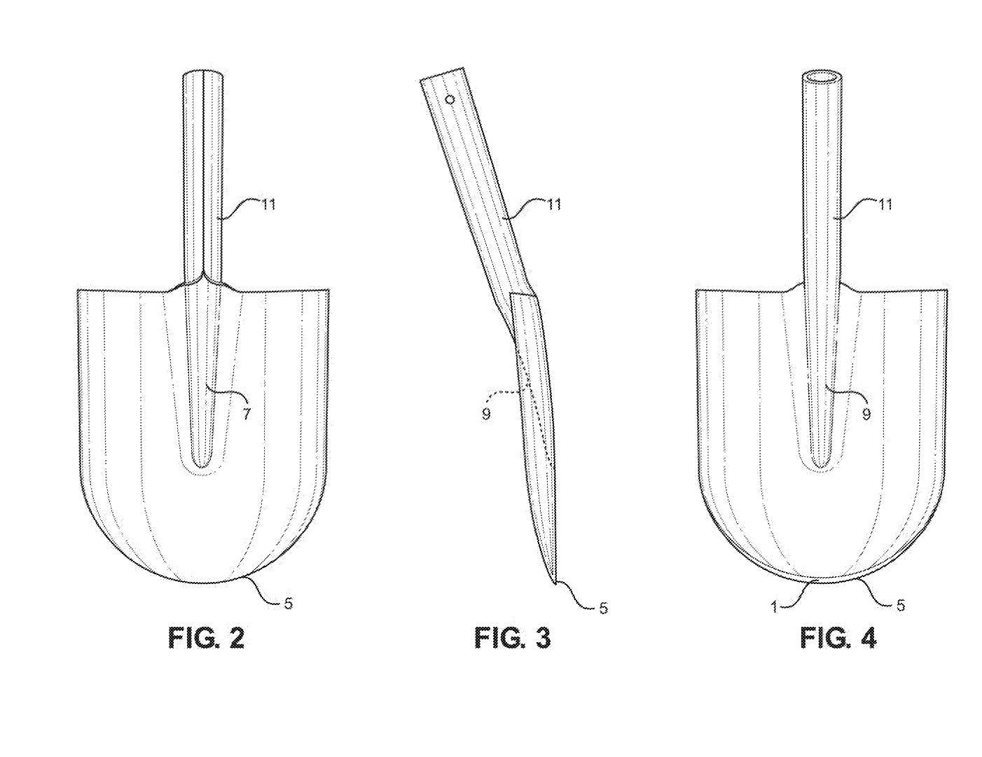

A blade (1) according to the teachings of the present invention has a ground contacting portion (5), which comprises the blade edge opposite the handle that contacts the ground when the shovel is in normal use. The ground contacting portion (5) is profiled to have an overall “U” shape. In a preferred embodiment, as shown in FIG. 1, the U-shape is partially abbreviated, further comprising a flattened section for breaking rock or other dense materials. Preferably, this flattened section has a length equal to or less than three inches.

The blade further comprises a frog (7), a shank (9), and a socket (11). Preferably, all portions of the blade (1), including the ground contacting portion (5), frog (7), shank (9), and socket (11), are integral to each other and formed from a single piece of steel. The frog (7) comprises an upward crimp formed into the body of the blade (1) to provide increased rigidity to the blade (1). The frog (7) extends backwardly and merges with a shank (9). The shank (9) comprises a transitional zone in which the material of the blade (1) transitions from a partial crimp at the frog (7) to a substantially enclosed roll at the socket (11).

The socket (11) comprises a substantially closed roll or tube adapted to hold and retain a handle (3). The socket (11) may be connected to the handle (3) by any conventional means of mechanical connection known to the art. Suitable connection means include, but are not limited to, rivets, screws, nails, and threaded connection. The socket (11) preferably allows removal and replacement of the handle (3) if the handle (3) is damaged or breaks. One or more collars may optionally be added inside or outside of the socket (1) to add additional strength and resistance to deformation (11).

A handle (3) according to embodiments of the present invention is a generally cylindrical rod of sufficient length to allow a user to use the shovel without undue stooping. The handle (3) is preferably solid, and is preferably comprised of a material with strength, yield, and fracture properties generally suitable for use in a heavy-duty shovel, as would be appreciated by one skilled in the art. Preferably, a handle (3) according to the present invention is selected to have a fracture strength equal to or lesser than the yield strength of the blade (1), thus protecting the blade (1) by increasing the chances that the less costly handle (3) will break before the blade (l) suffers significant deformation. Preferably, the handle (3) is made of fiberglass or reinforced fiberglass. It will be understood, however, that the fracture strength of the handle (3) should be as high as possible, up to an approximate limit defined by the yield strength of the blade (1), to maximize the force the shovel can tolerate in use. Optionally, the handle (3) may be selected to have a fracture strength greater than the yield strength of the blade (1).

Embodiments of the present invention further include a method of manufacturing the improved caprock shovel described herein. The method of the present invention comprises the steps of providing a rolled steel blank; stamping said blank into an improved caprock shovel blade wherein said blade comprises a ground contacting portion comprising an abbreviated U profile, a frog, a shank adjacent to said frog, and a socket adjacent to said shank; selecting a handle of desired length and characteristics, including strength, flexibility, and tactile characteristics; and connecting said handle to said socket.

Although the present invention has been described in considerable detail with reference to certain preferred versions thereof, other versions are possible. For example, materials, shapes, sized, or configurations other than those described in detail herein may be used for the versions of this invention. Therefore, the spirit and scope of the claims should not be limited to the description of the preferred versions described herein.

What is claimed is:

1. An improved caprock shovel comprising a stamped steel blade connected to a handle, wherein said blade comprises:
(a) a ground contacting portion with a U-shaped profile;
(b) a frog;
(c) a shank adjacent to said frog; and
(d) a socket adjacent to said shank.

2. The apparatus of claim 1, wherein said blade is formed substantially of 10-gauge steel.

3. The apparatus of claim 2, wherein said blade is formed substantially of rolled 1050 carbon steel.

4. The apparatus of claim 3, wherein said blade is heat-treated.

5. The apparatus of claim 4, wherein said blade has a yield strength equal to or greater than approximately 80,000 pounds per square inch.

6. The apparatus of claim 4, wherein said blade has a yield strength equal to or greater than approximately 110,000 pounds per square inch.

7. The apparatus of claim 5, wherein said handle has a fracture strength approximately equal to or less than the yield strength of said blade.

8. The apparatus of claim 7, wherein said handle has a fracture strength approximately equal to or less than the yield strength of said blade.

9. A method of manufacturing an improved caprock shovel, said method comprising the steps of:
(a) providing a rolled steel blank;
(b) stamping said rolled steel blank into a caprock shovel blade, wherein said blade comprises
(i) a ground contacting portion with a U-shaped profile;
(ii) a frog;
(iii) a shank adjacent to said frog; and
(iv) a socket adjacent to said shank;
(c) selecting a handle; and
(d) connecting said handle to said socket.

10. The method of claim 9, wherein said rolled steel blank comprises 10-gauge steel.

11. The method of claim 10, wherein said rolled steel blank is formed substantially of 1050 carbon steel.

12. The method of claim 11, further comprising the step of heat-treating said blade to improve strength characteristics.

13. The method of claim 12, wherein said blade has a yield strength equal to or greater than approximately 80,000 pounds per square inch.

14. The method of claim 12, wherein said blade has a yield strength equal to or greater than approximately 110,000 pounds per square inch.

15. The method of claim 13, wherein said step of selecting a handle comprises selecting a handle with a fracture strength approximately equal to or lesser than the yield strength of said blade.

16. The method of claim 14, wherein said step of selecting a handle comprises selecting a handle with a fracture strength approximately equal to or lesser than the yield strength of said blade.
